(19) United States
(12) Patent Application Publication
(10) Pub. No.: US 2005/0128478 A1
(43) Pub. Date: Jun. 16, 2005

(54) Optical unit and measuring apparatus having the same

(75) Inventors: Takayuki Hasegawa, Tokyo (JP); Akira Miyake, Nasu-gun (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/002,889

(22) Filed: Dec. 3, 2004

(30) Foreign Application Priority Data
Dec. 10, 2003 (JP) 2003-411783

(51) Int. Cl. G01T 1/36; G01J 3/28; G01B 11/24; G01B 11/30

(52) U.S. Cl. 356/328; 378/82

(57) ABSTRACT

An optical unit includes a spectrometer that includes a diffraction grating for separating light, and a beam intensity sensor for detecting a light intensity of light emitted from the spectrometer, wherein the beam intensity sensor includes, in order from a light incident side to a light exit side, an aperture having a first opening that restricts a width of incident light, and a light receiving sensor that has a second opening for detecting part of light from the aperture, wherein the second opening in the light receiving sensor is wider than the first opening in the aperture in a spectral direction of the light from the spectrometer, and wherein the second opening in the light receiving sensor is narrower than the first opening in the aperture in a direction orthogonal to the spectral direction of the light from the spectrometer.

### BACKGROUND OF THE INVENTION

The present invention relates to an optical unit and a measuring apparatus having the same, which are suitable, for example, for measurements of the optical performance, such as a reflectance and a transmittance, of an optical element for use with the X-ray, soft X-ray, and the extreme ultraviolet (“EUV”) light.

Various manufacturing devices have recently been proposed for semiconductor devices for use with the light having an extremely short wavelength, such as the X-ray, soft X-ray, and the EUV light. Accordingly, various measuring apparatuses have been proposed for measuring the optical performance of an optical element used for these manufacturing apparatuses.

For example, a measuring apparatus that evaluates sample's physical and chemical characteristics by irradiating the soft X-ray onto the sample includes a measuring apparatus that measures the mirror's reflectance and the filter's transmittance (see, for example, Journal of X-ray Science and Technology 3, pp 283-299 (1992). “A Soft X-Ray/EUV Reflectometer Based on a Laser Produced Plasma Source” (E. M. Gullikson, J. H. Underwood, P. C. Batson, and V. Nikitin)). This measuring apparatus irradiates the monochromatic light or the light of a single wavelength onto the sample, and measures the light intensity of light that has been reflected on the sample or that has transmitted through the sample. Other measuring apparatuses for detecting a relationship between the light and a sample, such as a photoelectron spectrometer and an X-ray fluorescence content meter, are used for various fields.

In order to obtain the monochromatic light, there is generally used a spectrometer for separating the white light from the light source and for extracting the light having only a specific wavelength.

FIGS. 6 and 7 are schematic views of a reflectance measuring apparatus for an optical element for use with the light having an extremely short wavelength as disclosed in the above reference. This measuring apparatus includes a light source means 101, a spectrometer MC, a beam intensity sensor BI, and a sensor 109.

In FIGS. 6 and 7, 101 denotes the EUV or X-ray light source. 102 denotes a prefocusing condenser mirror that condenses the EUV light or X-ray emitted from the light source 101. 103 denotes an incident slit. 104 denotes a diffraction grating for separating the EUV light or X-ray. 105 denotes an exit slit. 116 denotes a perforated IO monitor for measuring part of the incident light. 107 denotes an aperture. 108 denotes an optical element that is an object whose reflectance is to be measured. 109 denotes is a sensor that measures the light reflected by the optical element.

FIG. 8 graphically shows a structure of the conventional IO monitor 116. As shown in FIG. 8, the IO monitor 116 measures the light intensity outside the light incident upon the object, and forecasts, based on this light intensity, the light intensity of the light incident upon the object that passes through an opening in the IO monitor 116.

In order to measure the reflectance using the IO monitor 116 shown in FIG. 8, it is necessary to make the sensor 109 movable as shown in FIGS. 6 and 7, and to measure the sensitivity of the IO monitor 116 or a relationship between an output of the IO monitor 116 to the predetermined light and the light intensity of the light that passes through the IO monitor 116 before the optical element 108 or the object is measured.

The sensitivity measurement of the IO monitor 116 is defined, as shown in FIG. 7, as follows, where IOi is an output of the IO monitor 116 when the light that passes through the IO monitor 116 is directly incident upon the sensor 109, and Ii is an output of the sensor 109:

Ini=Ii/IOi

A coefficient used to calculate the light intensity of the light that passes through the IO monitor 116 from the output value of the IO monitor 116 at the actual measurement time is obtained as a division of the output Ii of the sensor 109 by the output IOi of the IO monitor 106.

Next, the optical element 108 is moved to an optical path as shown in FIG. 6, and the sensor 109 is moved to a position upon which the reflected light from the optical element is incident. Inr that is defined as follows is obtained, where Ir is an output of the sensor 109, and IOr is an output of the IO monitor 106:

Inr=Ir/IOr

from the above measurement, the reflectance R is calculated as follows:
R=Inr/Inr

As described above, the prior art reflectance measuring apparatus uses the light outside the light incident upon the optical element 108 for the measurement of the light intensity by the IO monitor 116 as shown in FIG. 8. This measurement disadvantageously deteriorates the precision, particularly when the light used for the measurement is the light separated by the spectrometer.

In other words, since the light separated by a diffraction grating, etc. forms a spectrum that has a wavelength distribution in the spectral direction, as shown in FIG. 9, the light whose light intensity is measured by the IO monitor 116 and the light that passes through the opening in the IO monitor 116 can have different wavelengths. In particular, the light radiated from the EUV light source and the X-ray light source often includes conspicuous emission lines in the spectrum that result from its generation principle, and has different light intensities depending upon its wavelengths.

Therefore, when the optical axis of the light incident upon the IO monitor 116 fluctuates in the spectral direction as shown by a dotted line in FIG. 9, the emission lines can enter the light receiving surface 116a of the IO monitor 116 and the sensitivity of the IO monitor 116 to the light that passes through the IO monitor 116 greatly changes. As a result, the measured reflectance contains errors disadvantageously.

The light radiated from the EUV light source and the X-ray light source may change the intensity distribution in the spectrum due to changes of the excitation states of a material that is excited in the light source and generates the EUV light and the X-ray. This case also causes errors with the conventional IO monitor 116 that measures the light intensity using the light having a wavelength different from that of the actually used light.

### BRIEF SUMMARY OF THE INVENTION

Accordingly, it is an exemplified general object of the present invention to provide an optical unit and a measuring apparatus having the same, which separates the light using a spectrometer, and accurately measures the optical performance of an optical element using the predetermined monochromatic light, even when the optical axis varies in a spectral direction of a spectrometer or the light from a light source fluctuates the intensity distribution in the spectrum.

An optical unit according to one aspect of the present invention includes a spectrometer that includes a diffraction grating for separating light, and a beam intensity sensor for detecting a light intensity of light emitted from the spectrometer, wherein the beam intensity sensor includes, in order from a light incident side to a light exit side, an aperture having a first opening that restricts a width of incident light, and a light receiving sensor that has a second opening for detecting part of light from the aperture, wherein the second opening in the light receiving sensor is wider than the first opening in the aperture in a spectral direction of the light from the spectrometer, and wherein the second opening in the light receiving sensor is narrower than the first opening in the aperture in a direction orthogonal to the spectral direction of the light from the spectrometer.

An optical unit according to another aspect of the present invention includes a spectrometer that includes a diffraction grating for separating light, and a beam intensity sensor for detecting a light intensity of light emitted from the spectrometer, wherein the beam intensity sensor includes, in order from a light incident side to a light exit side, an aperture having a first opening that restricts a width of incident light, and a light receiving sensor for detecting part of light from the aperture, wherein the light receiving sensor has two sensors that are spaced from each other by a predetermined interval in a direction orthogonal to a spectral direction of the light from the spectrometer, each of the two sensors forming a second opening that is wider than the first opening in the aperture in the spectral direction, and wherein the predetermined interval between the two sensors is narrower than the first opening in the aperture in the direction orthogonal to the spectral direction.

A measuring apparatus according to still another aspect of the present invention includes a light source, the above optical unit for separating light from the light source so as to introduce light having a predetermined spectrum to an object to be measured, and a light receiving unit for receiving light from the object.

### BRIEF DESCRIPTION OF THE DRAWINGS

FIG. 1 is a schematic view of a measuring apparatus according to a first embodiment of the present invention.

FIG. 2 is a view for explaining a light receiving element and an aperture according to the first embodiment of the present invention.

FIG. 3 is a view for explaining the light receiving element and the aperture according to the first embodiment of the present invention.

FIG. 4 is a view for explaining the light receiving element and the aperture according to a second embodiment of the present invention.

FIG. 5 is a schematic view of a measuring apparatus according to the first embodiment of the present invention.

FIG. 6 is a schematic view of a conventional spectral reflectance measuring apparatus.

FIG. 7 is a schematic view of a conventional spectral reflectance measuring apparatus.

FIG. 8 is a view for explaining an IO monitor and an aperture shown in FIG. 6.

FIG. 9 is a view for explaining an IO monitor and an aperture shown in FIG. 6.

### DETAILED DESCRIPTION OF THE PREFERRED EMBODIMENTS

A description will now be given of each embodiment of the present invention with reference to the accompanying drawings:

First Embodiment

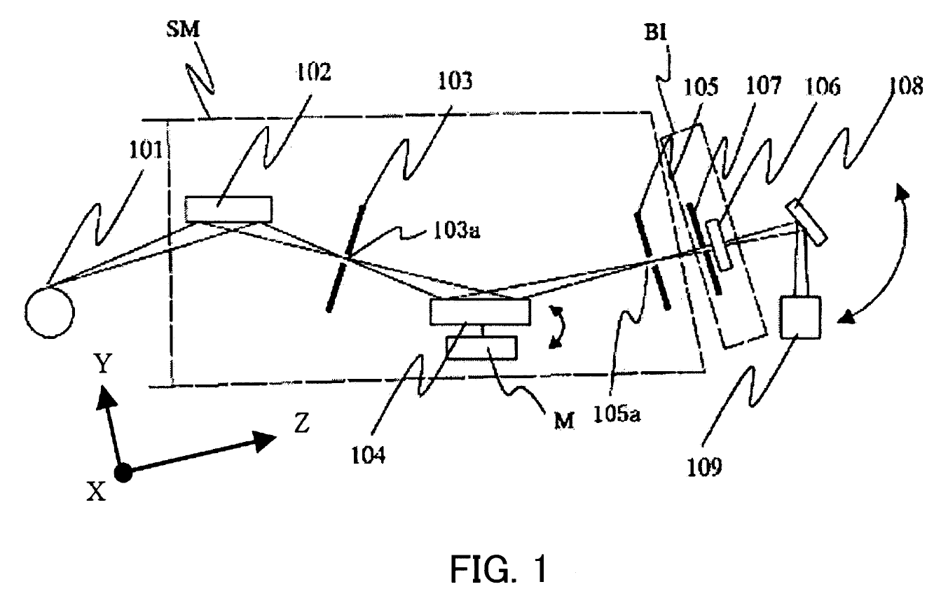

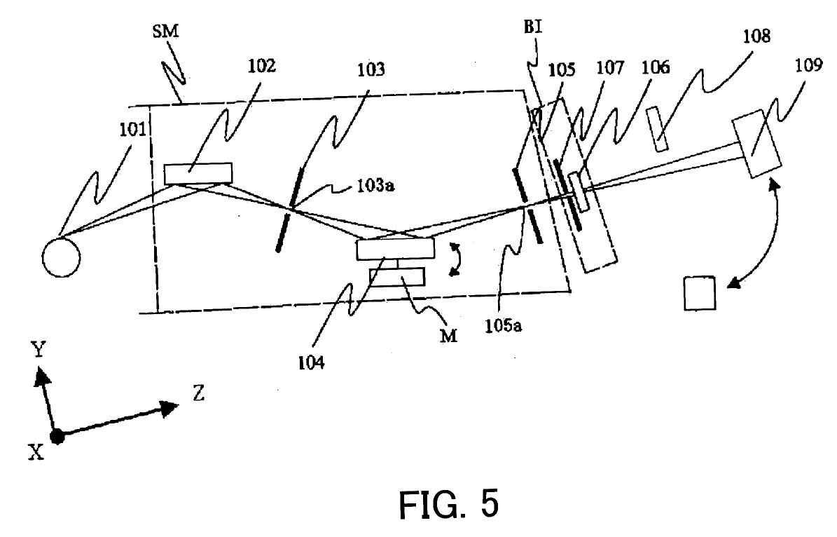

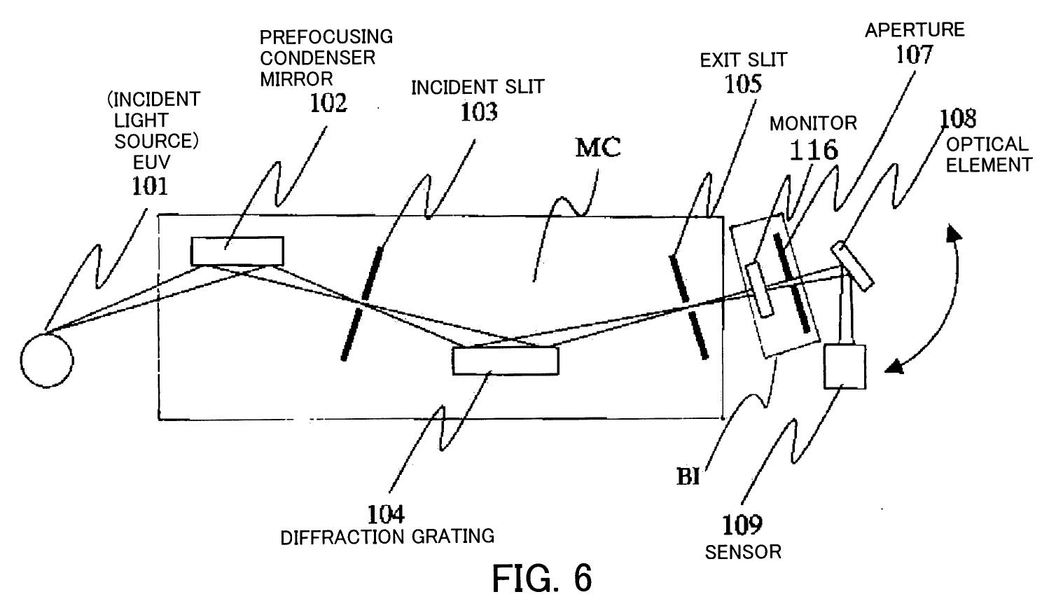

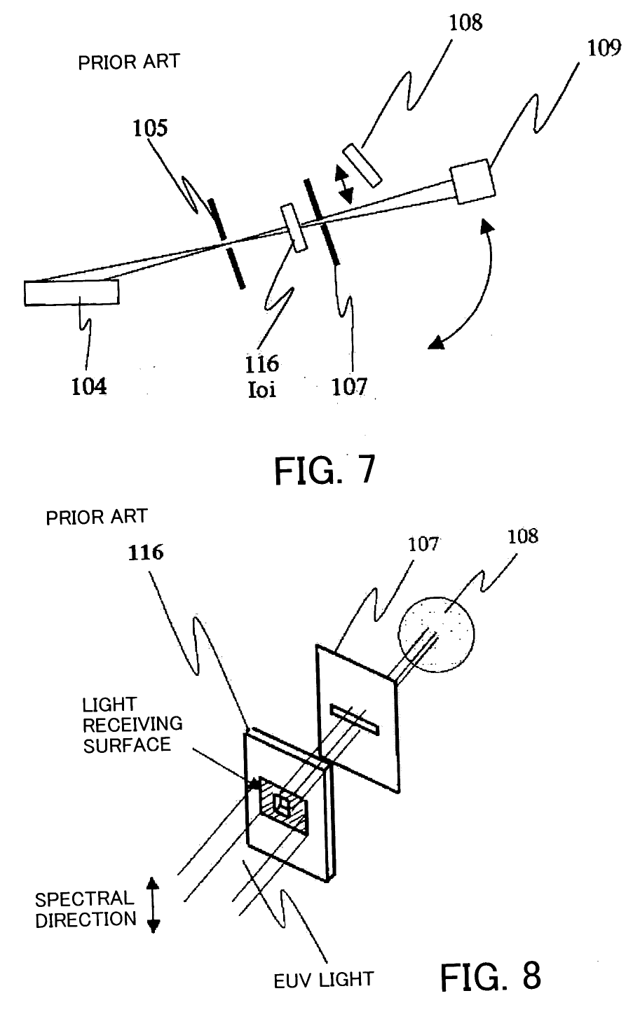

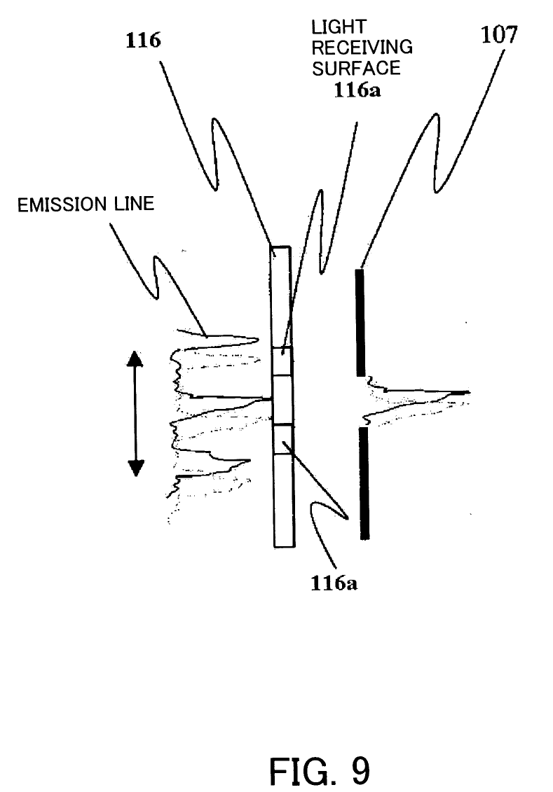

FIGS. 1 and 5 are schematic sectional views of a first embodiment when an inventive optical unit having a spectrometer and a beam intensity monitor is applied to a spectral reflectance measuring apparatus. In FIGS. 1 and 5, 101 denotes a light source means. SM denotes a spectrometer. BI is a beam intensity sensor. 108 denotes an optical element as an object to be measured. 109 denotes a light receiving means. The light source means 101 uses a synchrotron radiation facility, a laser plasma light source, etc. for radiating the light in a range of the EUV light and the X ray. The light source 101 emits the light having a continuous spectrum instead of a single wavelength.

The spectrometer SM includes a rotatable diffraction grating 104, and a drive means M for rotating the diffraction grating. The diffraction grating 104 separates the light from the light source means 101, and forms the spectrum on the exit slit 105. An opening 103a in a slit 103 and an opening 105a in the slit 105 have a conjugate relationship. When the diffraction grating 104 is manually rotated, the drive means M is unnecessary.

The beam intensity sensor BI includes an aperture 107, and a light receiving element 106. For simple descriptions, as shown in FIG. 1, a surface that includes an optical axis of the incident light upon the diffraction grating 104 and an optical axis of the diffracted light from the diffraction grating 104 is defined as an X surface, and an optical axis in the X surface which passes a center of the light receiving element 106 in the diffracted light from the diffraction grating 104 is defined as a Z axis.

A description will now be given of a reflectance measuring method of the optical element 108 in the instant embodiment.

From the configuration shown in FIG. 1, the optical element 108 is retreated from the optical path, and the light receiving means 109 is rotated for direct incidence of the light that passes through the opening in the beam intensity sensor BI.

In the state shown in FIG. 5, the light intensities output from the light receiving means 109 and the light receiving element 106 are measured. This is referred to as an incident light measurement. A result of the incident light measurement is defined as follows, where IOi is an output from the light receiving element 106, and Ii is an output from the light receiving means 109:
Ini=Ii/IOi

Ini indicates the sensitivity of the light receiving element 106 or a relationship between the output from the light receiving element 106 and the light intensity of the light that passes through the opening in the light receiving element 106.

Next, the optical element 108 is moved to an optical path, and inclined to the optical path by a predetermined angle. In addition, the light receiving means 109 is moved to a position, upon which the reflected light from the optical element 108 is incident, and the light intensities output from the light receiving means 109 and the light receiving element 106 are measured. This is referred to as a reflected light measurement. A result of the reflected light measurement is defined as follows, where Ir is an output from the light receiving means 109, and IOi is an output from the light receiving element 106:

Inr=Ir/IOr

From the above measurements, the reflectance R is calculated as follows:

R=Inr/Ini

While the instant embodiment describes the reflectance measurement of the optical element 108, the transmittance can also be measured in a similar manner.

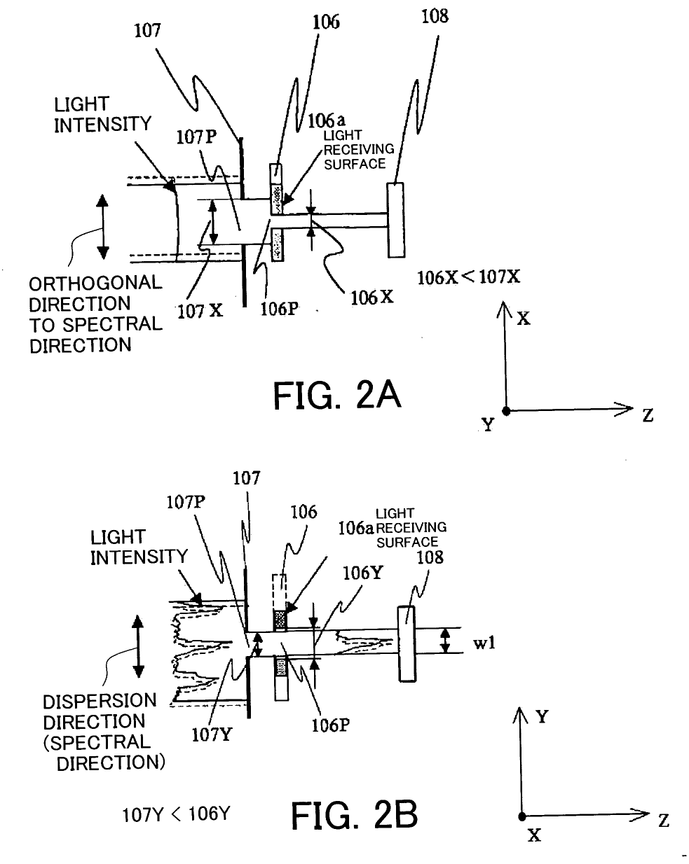

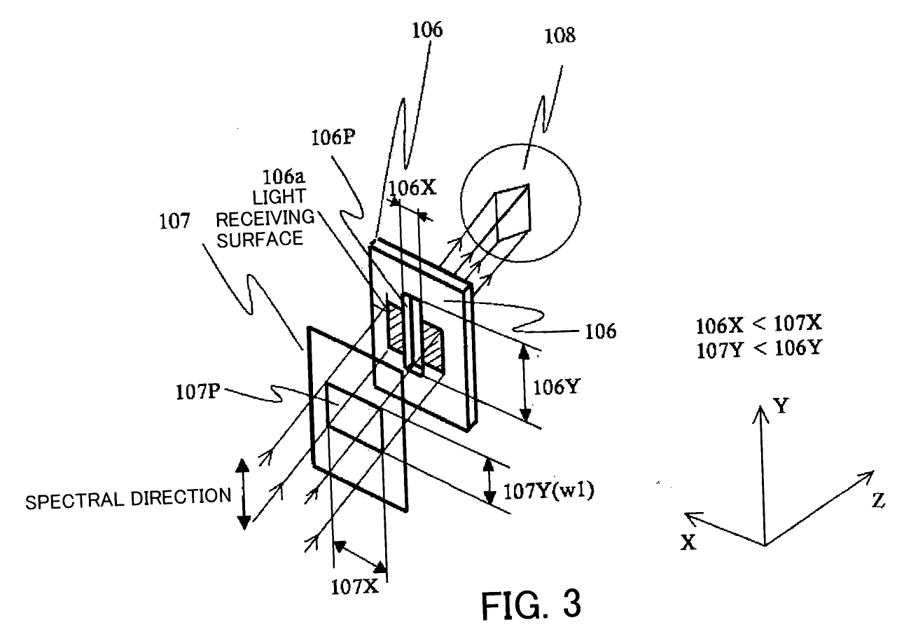

The beam intensity sensor BI in this embodiment arranges the aperture 107 that restricts the light incident upon the light receiving element 106 at the upstream side (or the incident light side) to the light receiving element 106. FIGS. 2A, 2B and 3 are schematic views showing positional relationship between and sizes of the opening 107P in the aperture and the opening 106P in the light receiving element 106 in the beam intensity sensor BI shown in FIG. 1.

FIG. 2A is a schematic view of a surface (or XZ plane) that includes a direction orthogonal to the spectral direction, or a plane that includes an optical axis that passes a center of the aperture 106P from the diffraction grating and is perpendicular to the paper plane shown in FIG. 1. FIG. 3B is a schematic view of the surface (or YZ plane) that includes a spectral direction (or a dispersion direction), on the paper plane shown in FIG. 1. FIG. 3 is a perspective view showing a relationship between the aperture 107 and the light receiving element 106.

This embodiment sets a width 106Y of the opening 106P in the light receiving element 106 greater than a width 107Y of the opening 107P in the aperture 107 in the dispersion direction, as shown in FIGS. 2B and 3.

In addition, as shown in FIGS. 2A and 3, a width 106X of the opening 106P in the light receiving element 106 is smaller than a width 107X of the opening 107P in the aperture 107 in a direction orthogonal to the spectral direction. Due to the relationship between the opening 107P in the aperture 107 and the opening 106P in the light receiving element 106, the wave range of the light incident upon the optical element 108 is always equal to the wave length of the light incident upon the light receiving surface 106a of the light receiving element 106. This structure can maintain constant a ratio between the light intensity of the light measured on the light receiving surface 106a and the light intensity of the light incident upon the optical element 108, irrespective of the spectral distributions, even when the optical axis position of the light fluctuates which passes through the opening 106P in the light-receiving element 106 and is incident upon the optical element 108 as an object to be measured.

A detailed description will now be given of the fluctuation of the optical axis (or a center axis) of the light, such as the EUV light or the X-ray, exit from the light source means 101. As shown by a dotted line in FIG. 2B, even when the optical axis moves to the spectral direction (or Y direction), a width of the light incident upon the optical element 108 and a width of the light incident upon the light receiving surface 106a of the light receiving element 106 are equal to w1. Therefore, the light receiving element 106 can correctly monitor the light intensity fluctuations of the light incident upon the optical element 108 caused by the fluctuations of the optical axis. As shown in FIG. 2A, when the optical axis moves in the direction orthogonal to the spectral direction (or X direction), the light incident upon the optical element 108 and the light incident upon the light receiving surface 106a of the light receiving element 106 have different positions, but the light intensity distribution in this direction is smaller than that in the spectral direction. Therefore, even if the optical axis fluctuates, the measurement errors are small on the light receiving element 106.

According to the beam intensity sensor BI in the instant embodiment, since a wavelength of the light used for the light intensity measurement of the light by the light receiving element 106 and a wavelength of the light incident upon the actual object to be measured are the same, the light intensity distribution can be properly measured, even when the intensity distribution fluctuates in the spectrum of the light radiated from the EUV or X-ray light source.

As described above, the beam intensity sensor BI in the instant embodiment arranges the aperture 107 that restricts the light exit from the light source means 101, closer to the light source means 101 than the light receiving element 106, and properly adjusts positions and sizes of the opening 107P in the aperture 107 and the opening 106P in the light receiving element 106. As a consequence, even when the optical axis of the light incident upon the light receiving element 106 fluctuates, the light intensity of the light incident upon the object can be measured with precision. More specifically, the light receiving element 106 is a sensor having an opening, and the width 106Y of the opening 106P is greater than the width 107Y of the opening 107P in the spectral direction as shown in FIG. 2B. In addition, the width 106X of the opening 106P is smaller than the width 107X of the opening 107P in the direction orthogonal to the spectral direction as shown in FIG. 2A. Even when the optical axis of the light exit from the light source means 101 fluctuates, the light receiving element 106 provides precise measurements.

In particular, the instant embodiment facilitates the more highly precise reflectance measurements by equalizing the width W1 and position on the light receiving element 116 in the spectral direction, of the reference light detected by the light receiving element 116 that for measuring the reference light that is not directly used for the reflectance measurement, to the width W1 and position on the light receiving element 116 in the spectral direction, of the measuring light that passes the light receiving element 116 and is directly used for the reflectance measurement.

Second Embodiment

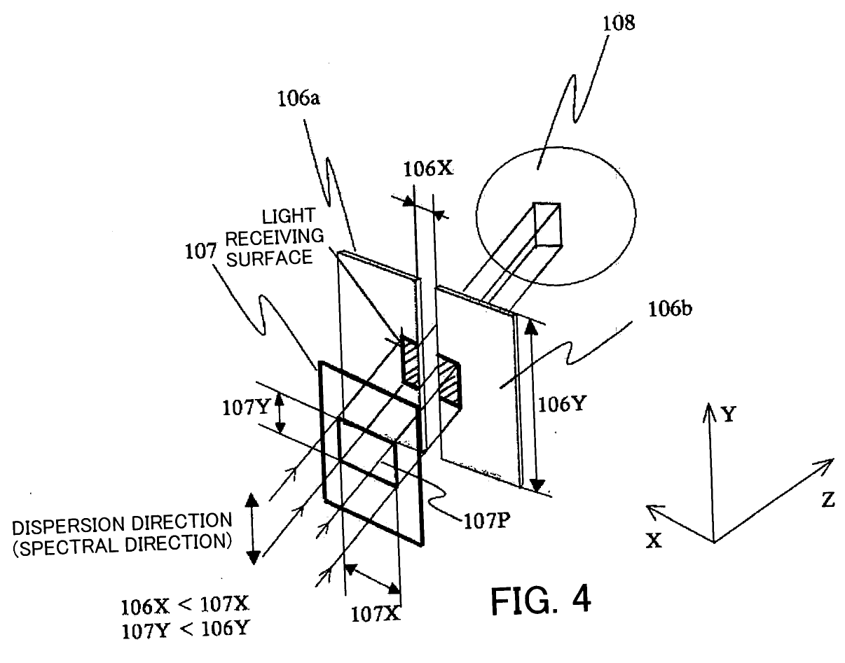

FIG. 4 is a view for explaining the light receiving element 106 used in a second embodiment of the present invention. The second embodiment is similar to the first embodiment except that the second embodiment arranges two sensors 106a and 106b spaced by a predetermined interval instead of the light receiving element 106.

As shown in FIG. 4, two sensor 106a and 106b are arranged and spaced from each other by a predetermined interval 106X in the direction orthogonal to the spectral direction (or X direction). An interval between the two sensors 106a and 106b is set smaller than a width 107X of the opening 107P in the aperture 107. This arrangement equalizes the width in spectral direction of the light incident upon the optical element 108 and the light incident upon the light receiving surface 106a of the light receiving element 106, and provides similar effects to those of a case where a perforated sensor is arranged as in the first embodiment.

Thus, an arrangement of two sensors with an interval as described provides highly precise measurements of the light receiving element.

Thus, the present invention can measure the optical performance of the optical element with precision, even when the optical axis fluctuates in the spectral direction of the spectrometer.

This application claims a foreign priority based on Japanese Patent Application No. 2003-411783, filed Dec. 10, 2003, which is hereby incorporated by reference herein.

1. An optical unit comprising:
a spectrometer that includes a diffraction grating for separating light; and
a beam intensity sensor for detecting a light intensity of light emitted from said spectrometer,
wherein said beam intensity sensor includes, in order from a light incident side to a light exit side, an aperture having a first opening that restricts a width of incident light, and a light receiving sensor that has a second opening for detecting part of light from the aperture,
wherein the second opening in the light receiving sensor is wider than the first opening in the aperture in a spectral direction of the light from said spectrometer, and
wherein the second opening in the light receiving sensor is narrower than the first opening in the aperture in a direction orthogonal to the spectral direction of the light from said spectrometer.

2. An optical unit according to claim 1, wherein the light receiving sensor includes a light receiving section that is located in the direction orthogonal to the spectral direction with respect to the second opening in the light receiving sensor.

3. An optical unit comprising:
a spectrometer that includes a diffraction grating for separating light; and
a beam intensity sensor for detecting a light intensity of light emitted from said spectrometer,
wherein said beam intensity sensor includes, in order from a light incident side to a light exit side, an aperture having a first opening that restricts a width of incident light, and a light receiving sensor for detecting part of light from the aperture,
wherein the light receiving sensor has two sensors that are spaced from each other by a predetermined interval in a direction orthogonal to a spectral direction of the light from said spectrometer, each of the two sensors forming a second opening that is wider than the first opening in the aperture in the spectral direction, and
wherein the predetermined interval between the two sensors is narrower than the first opening in the aperture in the direction orthogonal to the spectral direction.

4. A measuring apparatus comprising:
a light source;
an optical unit according to claim 1 or 3 for separating light from the light source so as to introduce light having a predetermined spectrum to an object to be measured; and
a light receiving unit for receiving light from the object.

5. A measuring apparatus according to claim 4, wherein the light source emits extreme ultraviolet light or X-ray.
